(19) United States
(12) Patent Application Publication
(10) Pub. No.: US 2012/0087004 A1
(43) Pub. Date: Apr. 12, 2012

(54) OPTICAL COMB GENERATOR

(75) Inventors: Oh-Kee KWON, Daejeon (KR); Chul-Wook Lee, Daejeon (KR); Dong-Hun Lee, Daejeon (KR); Young Ahn Leem, Daejeon (KR); Young-Tak Han, Daejeon (KR); Yongsoon Baek, Daejeon (KR)

(73) Assignee: ELECTRONICS AND TELECOMMUNICATIONS RESEARCH INSTITUTE, Daejeon (KR)

(21) Appl. No.: 13/019,299

(22) Filed: Feb. 1, 2011

(30) Foreign Application Priority Data
Oct. 6, 2010 (KR) 10-2010-0097296
Oct. 14, 2010 (KR) 10-2010-0100398

(51) Int. Cl. G02F 1/365

(52) U.S. Cl. 359/326

(57) ABSTRACT

Provided is an optical comb generator including a light source, a first waveguide region, a modulation region, and a second waveguide region. The light source is configured to output single-mode light. The first waveguide region divides an output of the light source into first light and second light. The modulation region includes a first modulator and a second modulator modulating the first light and the second light respectively. The second waveguide region combines outputs of the first modulator and the second modulator to output an optical comb. Here, the first modulator and the second modulator respectively include a first quantum well and a second quantum well having an asymmetric structure with respect to each other. The light source, the first waveguide region, the modulation region, and the second waveguide region are integrated into one substrate.

### CROSS-REFERENCE TO RELATED APPLICATIONS

This U.S. non-provisional patent application claims priority under 35 U.S.C. §119 of Korean Patent Application Nos. 10-2010-0097296, filed on Oct. 6, 2010, and 10-2010-0100398, filed on Oct. 14, 2010, in the Korean Intellectual Property Office (KIPO), the entire contents of which are hereby incorporated by reference.

### BACKGROUND OF THE INVENTION

The present invention disclosed herein relates to an optical comb generator.

An optical comb or optical frequency comb generator is an apparatus that generates a periodic pulse train in a time or frequency domain. The optical comb generator gained the Novel prize in 2005, in which a Professor, John Hall, at the National Institute of Standard and Technology (NIST) implemented optical atomic clocks in the field of frequency metrology using an optical comb.

Thereafter, application of the optical comb has been demonstrated, and then many studies related to the optical comb are being conducted in various fields such as metrology, spectroscopy, THz pulse generation, chemical analysis, Radio Frequency (RF) photonics, and optical communication.

### SUMMARY OF THE INVENTION

The present invention provides an optical comb generator that is integrated in one substrate.

The present invention also provides an optical comb generator that is implemented in an array form on one substrate.

Embodiments of the present invention provide optical comb generators including: a light source configured to output single-mode light; a first waveguide region dividing an output of the light source into first light and second light; a modulation region including a first modulator and a second modulator modulating the first light and the second light respectively; and a second waveguide region combining outputs of the first modulator and the second modulator to output an optical comb, wherein the first modulator and the second modulator respectively include a first quantum well and a second quantum well having an asymmetric structure with respect to each other, and the light source, the first waveguide region, the modulation region, and the second waveguide region are integrated into one substrate.

In some embodiments, the first and second modulators may further include: a first semiconductor layer having a first conductive type and stacked on the substrate; and a second semiconductor layer provided on the first quantum well and the second quantum well and having a second conductive type different from the first conductive type, respectively. The first quantum well and the second quantum well may be provided on the first semiconductor layer.

In other embodiments, the first quantum well and the second quantum well may have different thicknesses.

In still other embodiments, the first quantum well and the second quantum well may have different bandgaps.

In even other embodiments, the first quantum well and the second quantum well may have different thicknesses and different bandgaps.

In yet other embodiments, the first semiconductor layer, the first quantum well, the second quantum well, and the second semiconductor layer may be reverse-biased.

In further embodiments, a potential barrier between the first quantum well and the second quantum well may have a thickness in which the first quantum well and the second quantum well are mutually combined.

In still further embodiments, the thickness of the potential barrier between the first quantum well and the second quantum well may be less than about 7 nanometers.

In even further embodiments, a thickness of the first quantum well may be equal to or less than a thickness of the second quantum well. Also, the thickness of the second quantum well may be less than about 12 nanometers.

In yet further embodiments, the modulation region may further include: a first potential electrode that is disposed on the first modulator and a sinusoidal wave is applied to; a second potential electrode that is disposed on the second modulator and a sinusoidal wave is applied to; at least one third potential electrode that is disposed at an upper portion of at least one of the first modulator and the second modulator to be spaced from the first potential electrode and the second potential electrode and a constant voltage is applied to; and at least one ground electrode that is disposed on the substrate to be adjacent to the first modulator and the second modulator and is grounded.

In much further embodiments, the first waveguide region may include an input arm guiding output light from the light source, and first and second arms dividing and outputting the guided light into first light and second light, respectively. Also, the second waveguide region may include third and fourth arms configured to guide modulated lights in the first and second modulators, respectively, and an output arm combining and outputting the guided lights through the third and fourth arms.

In still much further embodiments, the output arm may have an inclined structure with respect to an axial line along which the input arm is provided on the substrate.

In other embodiments of the present invention, optical comb generators include: a plurality of light sources generating single-mode lights having different wavelengths; a plurality of modulation units corresponding to the plurality of light sources, and configured to modulate output lights from the plurality of light sources to output optical combs having different central wavelengths, respectively; and a multiplexer configured to multiplex outputs of the plurality of modulation units to output, wherein a first modulator and a second modulator include at least two quantum wells having an asymmetric structure with respect to each other, respectively, and the plurality of light sources, the plurality of modulation units, and the multiplexer are integrated into one substrate.

In some embodiments, the at least two quantum wells may be mutually combined.

In other embodiments, the at least two quantum wells may have different thicknesses.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating an optical comb generator according to an embodiment of the present invention;

FIG. 2 is a cross-sectional view taken along line I-I′ of FIG. 1;

FIG. 3 is a cross-sectional view taken along line II-II′ of FIG. 1;

FIG. 4 is a diagram illustrating a bandgap of a coupled asymmetric multiple quantum well structure of each modulator;

FIG. 5 is a diagram illustrating energies of quantum wells of a coupled asymmetric multiple quantum well structure according to an embodiment of the present invention;

FIG. 6 is a diagram illustrating energies of quantum wells when a bias voltage is applied to a coupled asymmetric multiple quantum well structure according to an embodiment of the present invention;

FIG. 7 is a graph illustrating a variation of an absorption coefficient according to a bias voltage;

FIG. 8 is a graph illustrating a variation of a refractive index according to a bias voltage;

FIG. 9 is a graph illustrating an absorption coefficient according to a variation of a bias voltage of a typical multiple quantum well structure.

FIG. 10 is a graph illustrating a variation of a refractive index according to a variation of a bias voltage of a typical multiple quantum well structure.

FIG. 11 is a diagram illustrating an optical comb generator with electrodes added according to a first embodiment;

FIG. 12 is a cross-sectional view taken along line III-III′ of FIG. 11;

FIG. 13 is a diagram illustrating an optical comb generator with electrodes added according to a second embodiment;

FIG. 14 is a diagram illustrating a diagram illustrating an optical comb generator with electrodes added according to a third embodiment;

FIG. 15 is a diagram illustrating an optical comb generation package according to a first embodiment of the present invention;

FIG. 16 is a diagram illustrating an optical comb generation package according to a second embodiment of the present invention; and

FIG. 17 is a flowchart illustrating an optical comb generation method according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout.

Hereinafter, it will be described about an exemplary embodiment of the present invention in conjunction with the accompanying drawings.

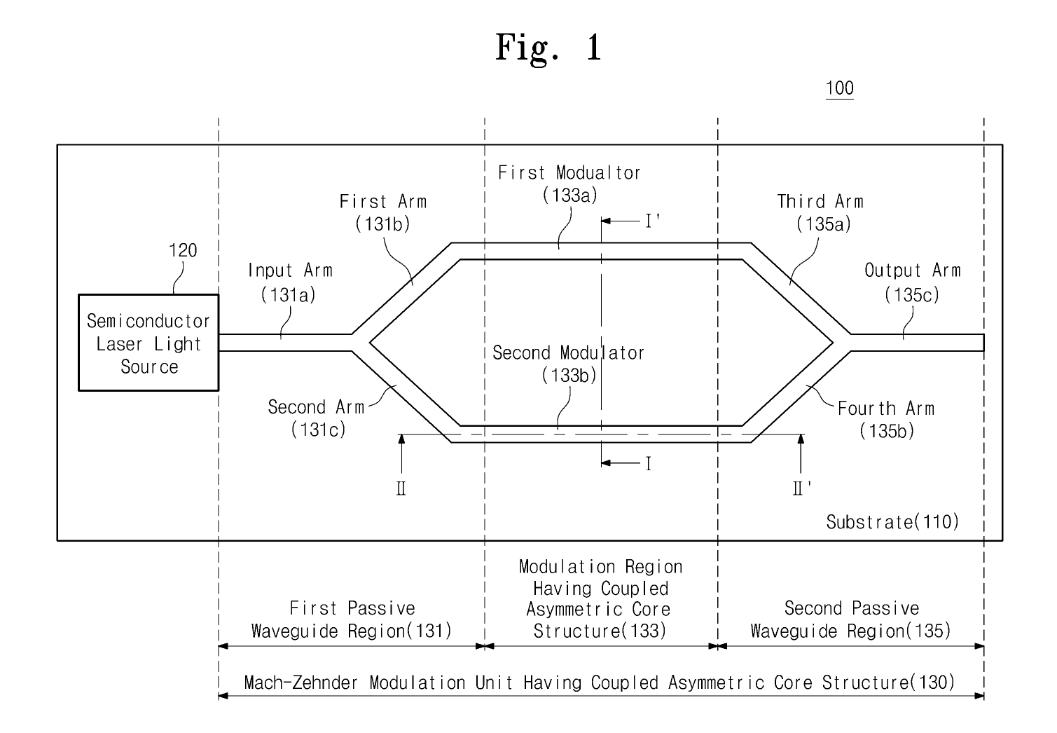

FIG. 1 is a diagram illustrating an optical comb or optical frequency comb generator 100 according to an embodiment of the present invention. Referring to FIG. 1, the optical comb generator 100 may include a substrate 110, a semiconductor laser light source 120, and a Mach-Zehnder modulation unit 130 having a core structure of a coupled asymmetric multiple quantum well. For simplicity of explanation, the Mach-Zehnder modulation unit 130 having the core structure of the coupled asymmetric multiple quantum well according to an embodiment of the present invention will be simply referred to as the Mach-Zehnder modulation unit 130. That is, the Mach-Zehnder modulation unit 130 mentioned below may have a coupled asymmetric core structure.

The substrate 110 may be formed of a single material. For example, the substrate 110 may be formed of indium phosphide.

The semiconductor laser light source 120 and the Mach-Zehnder modulation unit 130 may be provided on the substrate 110. That is, the optical comb generator 100 including the substrate 110, the semiconductor laser light source 120, and the Mach-Zehnder modulation unit 130 may be integrated into a single chip.

The semiconductor laser light source 120 may include a Distributed FeedBack Laser Diode (DFB LD).

The Mach-Zehnder modulation unit 130 may include a first passive waveguide region 131, a coupled asymmetric modulation region 133, and a second passive waveguide region 135.

The first passive waveguide region 131 may include an input arm 131a provided on the substrate 110, a first arm 131b, and a second arm 131c. The input arm 131a may guide output light of the semiconductor laser light source 120.

The first and second arms 131b and 131c may divide and guide light delivered through the input arm 131a. As illustrated in FIG. 1, the input arm 131a, the first arm 131b, and the second arm 131c may form a Y-shape. The input arm 131a, the first arm 131b, and the second arm 131c may include a bulk core.

The modulation region 133 having a core structure of a coupled asymmetric multiple quantum well may be an active region in which modulation is performed. Hereinafter, the modulation region 133 having the core structure of the coupled asymmetric multiple quantum well according to an embodiment of the present invention may be simply referred to as the modulation region 133. The modulation region 133 may include a first modulator 133a and a second modulator 133b that are provided on the substrate 110. The first modulator 133a may guide output light of the first arm 131b of the first passive waveguide region 131, and may modulate the guided light to output it. The second modulator 133b may guide output light of the second arm 131c, and may modulate the guided light to output it. The respective modulators may have a multiple quantum well (MQW) structure.

The second passive waveguide region 135 may include a third arm 135a, a fourth arm 135b, and an output arm 135c that are provided on the substrate 110. The third arm 135a may be configured to guide the output light of the first modulator 133a. The fourth arm 135b may be configured to guide the output light of the second modulator 133b. The output arm 135c may be configured to combine and output the output light of the third arm 135a and the fourth arm 135b. As illustrated in FIG. 1, the third arm 135a, the fourth arm 135b, and the output arm 135c may form a Y-shape. The third arm 135a, the fourth arm 135b, and the output arm 135c may include a bulk core.

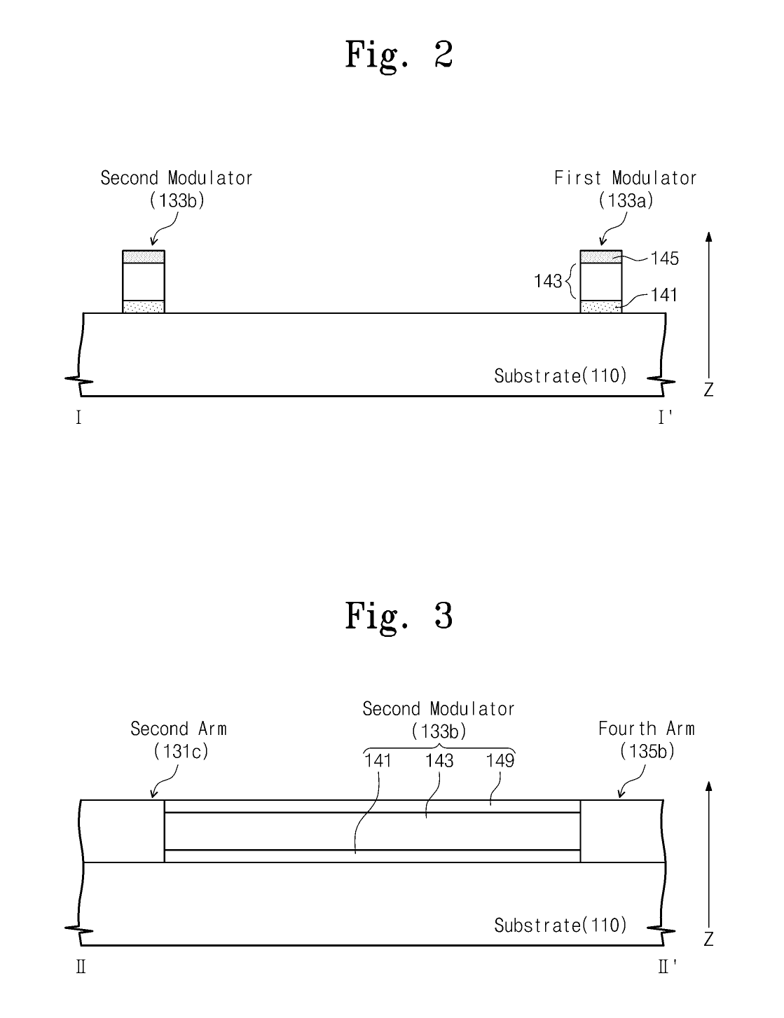

FIG. 2 is a cross-sectional view taken along line I-I′ of FIG. 1. For example, a cross-section of the Mach-Zehnder 130 is shown.

FIG. 3 is a cross-sectional view taken along line II-II′ of FIG. 1. For example, a cross-section of a portion of the second arm 131c, the second modulator 133b, and a portion of the fourth arm 135b is shown.

Referring to FIGS. 1 through 3, the respective modulators may include a first layer 141, a second layer 143, and a third layer 145 that are sequentially stacked on the substrate 110.

A first layer 141 may be formed of a semiconductor material having a first conductive type. For example, the first layer 141 may be formed of a semiconductor material having a P or N conductive type.

The third layer 145 may be formed of a semiconductor material having a second conductive type different from the first conductive type. For example, the third layer 145 may be formed of a semiconductor material having an N or P conductive type.

The second layer 143 may have a coupled asymmetric multiple quantum well (CAMQW) structure. The second layer 143 may include an intrinsic semiconductor.

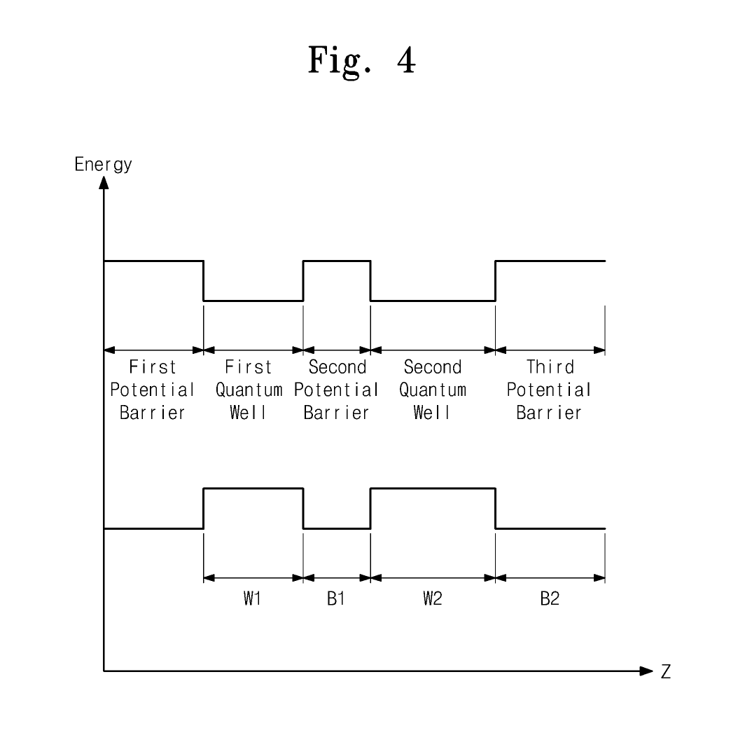

FIG. 4 is a diagram illustrating a bandgap of a coupled asymmetric multiple quantum well structure of each modulator. In FIG. 4, the horizontal axis corresponds to the z-axis. The z-axis indicates a vertical direction to the substrate 110. The vertical axis corresponds to energy.

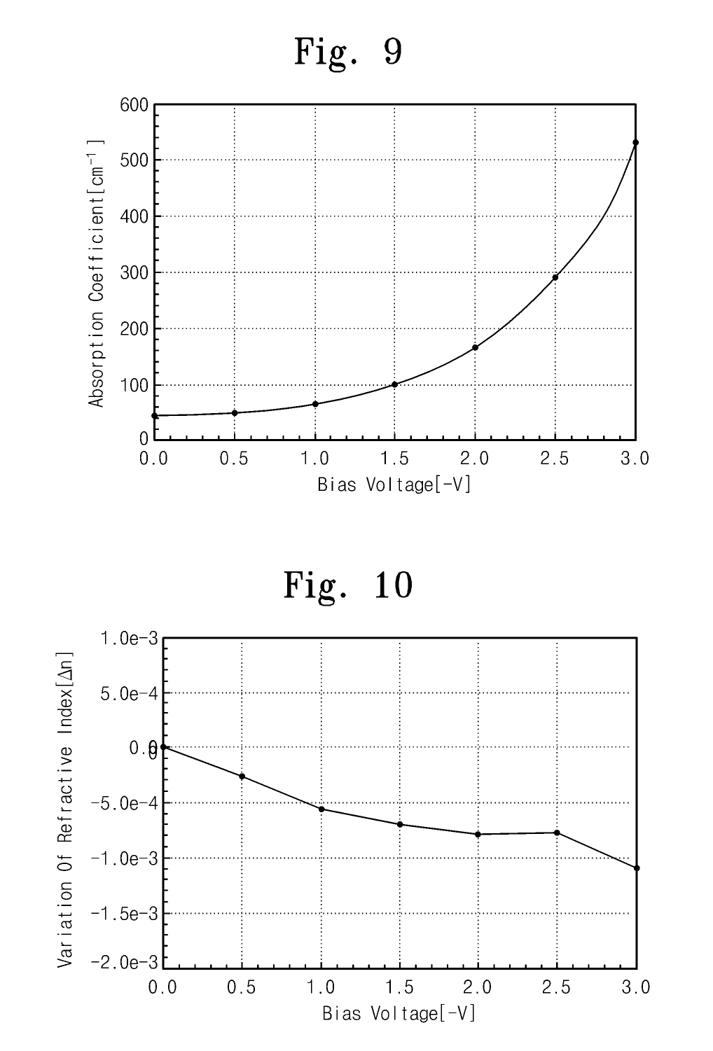

As illustrated in FIG. 9, a first quantum well and a second quantum well, and first through third potential barriers are shown. However, the number of the quantum wells of a coupled asymmetric multiple quantum well structure is not limited thereto.

In the first quantum well, an energy gap between the valence band and the conduction band may be smaller than that between the valence band and the conduction band of each potential barrier. In the second quantum well, an energy gap between the valence band and the conduction band may be smaller than that between the valence band and the conduction band of each potential barrier.

The first quantum well and the second quantum well may have an asymmetric structure to each other. For example, it is shown in FIG. 4 that the thickness W1 of the first quantum well is less than the thickness W2 of the second quantum well. For example, the thickness W1 of the first quantum well may be equal to or less than the thickness W2 of the second quantum well. The thickness W2 of the second quantum well may be equal to or less than about 12 nanometers.

In another embodiment, although not shown, the first and second quantum wells may have the same thickness, but may have different bandgaps.

In another embodiment, although not shown, the first and second quantum wells may have different thicknesses and bandgaps.

The thickness B1 of the second potential barrier between the first quantum well and the second quantum well may be configured such that the first quantum well and the second quantum well are coupled to each other. For example, the thickness B1 of the second potential barrier may be equal to or less than about 7 nanometers. That is, the first and second quantum wells having asymmetric structure to each other may be coupled to each other.

The first quantum well and the second quantum well may be provided in pair in which they are coupled to each other. In the coupled asymmetric multiple quantum well according to an embodiment of the present invention, pairs of the quantum wells coupled to each other may be additionally provided. In this case, the thickness of the potential barrier provided between the pairs of the quantum wells may be configured such that coupling between the pairs of the quantum wells is prevented.

For example, the thickness B2 of the third potential barrier may be configured to prevent coupling between a pair of the first quantum well and the second quantum well and a pair of quantum wells that are additionally provided on the right side of the third potential barrier. The thickness B2 of the third potential barrier may be greater than about 7 nanometers.

FIG. 5 is a diagram illustrating energies of quantum wells of a coupled asymmetric multiple quantum well structure according to an embodiment of the present invention. Potential barriers and quantum wells of FIG. 5 will be described in accordance with the terms described in FIG. 4.

For example, the energies of the first quantum well and the second quantum well when the thicknesses of the first quantum well, the second quantum well, and the second potential barrier are about 6 nanometers, about 7.5 nanometers, and about 4 nanometers, respectively, are shown in FIG. 5.

In the coupled asymmetric multiple quantum well structure including the first and second quantum wells, electrons of the conduction band and holes of the valence band may be quantized to be expressed as eigenvalues, respectively.

In FIG. 5, a first eigenvalue EV1 corresponding to first energy of the conduction bands of the first quantum well and the second quantum well is shown as a first energy level L1. Also, a second eigenvalue EV2 corresponding to second quantization energy of the conduction bands of the first quantum well and the second quantum well is shown as a second energy level L2.

In FIG. 5, a third eight value EV3 corresponding to first energy of the valence band of the first quantum well and the second quantum well is shown as a third energy level L3. Also, a fourth eigenvalue EV4 corresponding to second energy of the valence band of the first quantum well and the second quantum well is shown as a fourth energy level L4.

In the coupled asymmetric multiple quantum well structure including the first and second quantum wells, a probability distribution function corresponding to the eigenvalue EV1 to EV4 of the first and second quantum wells may be expressed as eigenfunctions.

In FIG. 5, a first eigenfunction EF1 corresponding to the first energy level L1 of the conduction band of the first quantum well and the second quantum well. Also, a second eigenfunction EF2 corresponding to a first energy distribution of the conduction band of the first quantum well and the second quantum well is shown. For example, the energy distribution of the conduction band of the first quantum well and the second quantum well may correspond to the distribution of electrons.

In FIG. 5, a third eigenfunction EF3 corresponding to a first energy distribution of the valence band of the first quantum well and the second quantum well is shown. Also, a fourth eigenfunction EF4 corresponding to the first energy distribution of the valence band of the first quantum well and the second quantum well is shown. For example, the energy distribution of the valence band of the first quantum well and the second quantum well may correspond to the distribution of holes.

Referring to the energy distribution of the conduction band of the first quantum well and the second quantum well, the first eigenfunction EF1 may have a higher probability distribution at the second quantum well than that at the first quantum well. The second eigenfunction EF2 may have a higher probability distribution at the first quantum well than that at the second quantum well. However, due to occurrence of tunneling in the second potential barrier, the first eigenfunction EF1 and the second eigenfunction EF2 may together exist in the first quantum well and the second quantum well. That is, the first quantum well and the second quantum well may be coupled to each other.

Referring to the energy distribution of the valence band of the first quantum well and the second quantum well, holes may be confined in the first quantum well and the second quantum well. That is, tunneling may be prevented at the second potential barrier. Since the mass of hole is greater than that of electron, the hole may be prevented from jumping the second potential barrier to be combined.

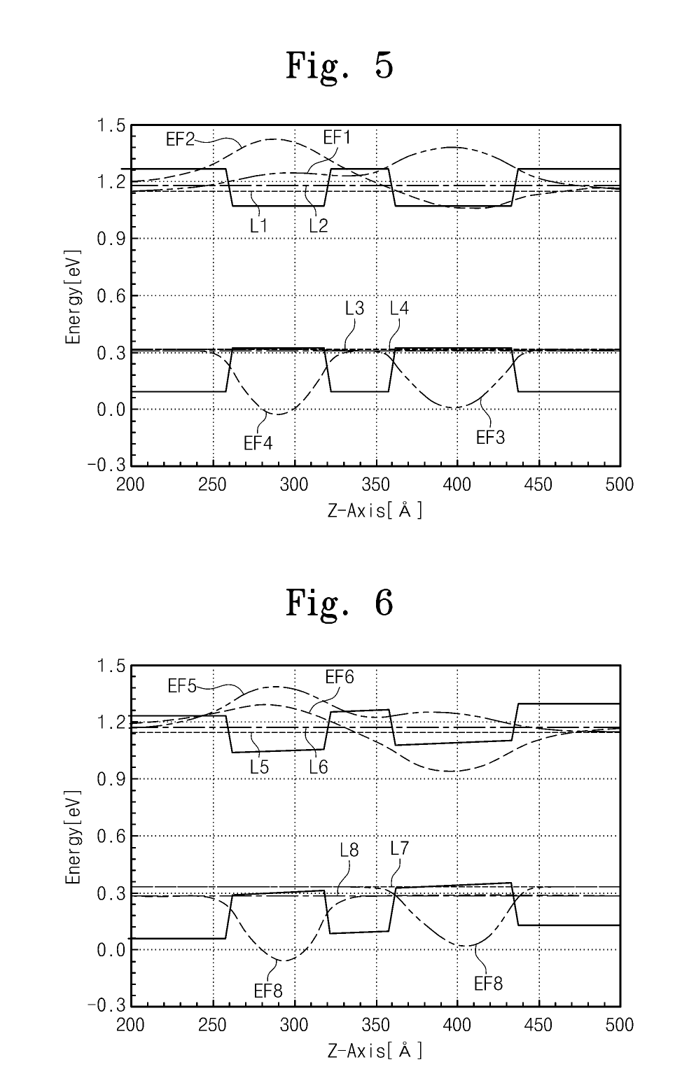

FIG. 6 is a diagram illustrating energies of quantum wells when a reverse bias voltage is applied to a coupled asymmetric multiple quantum well structure according to an embodiment of the present invention. In FIG. 6, the potential barriers and the quantum wells will be described according to the terms shown in FIG. 4.

For example, energies of the first quantum well and the second quantum well when the thicknesses of the first quantum well, the second quantum well, and the second potential barrier are about 6 nanometer, about 7.5 nanometers, and about 4 nanometers, respectively, and a reverse bias voltage (or forward bias voltage of about −1.5 V) of about 1.5 V is applied to the first layer 141 having a first conductive type is shown in FIG. 6.

In FIG. 6, a fifth eigenvalue EV5 corresponding to first energy of the conduction band of the first quantum well and the second quantum well is shown as a first energy level L5. Also, a sixth eigenvalue EV6 corresponding to second energy of the conduction band of the first quantum well and the second quantum well is shown as a sixth energy level L6.

In FIG. 6, a seventh eigenvalue EV7 corresponding to first energy of the valence band of the first quantum well and the second quantum well is shown as a seventh energy level L7. Also, an eighth eigenvalue EV8 corresponding to second energy of the valence band of the first quantum well and the second quantum well is shown as an eight energy level L8.

In FIG. 6, a fifth eigenfunction EF5 corresponding to a first energy distribution of the conduction band of the first quantum well and the second quantum well is shown. Also, a sixth eigenfunction EF6 corresponding to the first energy distribution of the conduction band of the first quantum well and the second quantum well is shown.

In FIG. 6, a seventh eigenfunction EF7 corresponding to a first energy distribution of the valence band of the first quantum well and the second quantum well is shown. Also, an eighth eigenfunction EF8 corresponding to the first energy distribution of the valence band of the first quantum well and the second quantum well.

A bias voltage may be applied to the coupled asymmetric multiple quantum well structure may be applied such that a voltage at the side of the third potential barrier becomes greater than that at the first potential barrier. In this case, a bandgap of the coupled asymmetric multiple quantum well structure may vary. For example, compared to the bandgap shown in FIG. 5, energy at the side of the third potential barrier may become greater than that on the first potential barrier in FIG. 6. That is, the maximum energy of the valence band at the side of the third potential barrier may become greater than the maximum energy of the valence band at the first potential barrier. Also, the minimum energy of the conduction band at the side of the third potential barrier may become greater than the minimum energy at the side of the first potential barrier.

The band gap of the second quantum well may become higher than the band gap of the first quantum well. That is, the maximum energy of the valence band of the second quantum well may become higher than the maximum energy of the valence band of the first quantum well. The minimum energy of the conduction band of the second quantum well may become greater than the minimum energy of the conduction band of the first quantum well.

In one embodiment, compared to the band gap of FIG. 5, the coupled asymmetric multiple quantum well (CAMQW) structure may have an increasing potential when progressing in the z direction. That is, as a negative voltage is applied to the first layer having a first conductive type (e.g., p conductive type) and contacting the coupled asymmetric multiple quantum well (CAMQW) structure, the potential of the coupled asymmetric multiple quantum well (CAMQW) structure may have an increasing gradient when progressing in the z direction.

Referring to the energy distribution of the conduction bands of the first quantum well and the second quantum well, the fifth eigenfunction EF6 may have a higher probability distribution at the second quantum well than that at the first quantum well. That is, compared to the energy distribution of FIG. 5, the location of the eigenfunction may be mutually moved.

Referring to the energy distribution of the valence bands of the first quantum well and the second quantum well, holes may be confined in the first quantum well or the second quantum well. That is, tunneling may be prevented at the second potential barrier. Since the mass of hole is greater than that of electron, the hole may be prevented from jumping the second potential barrier to be combined.

In compliance with a Quantum Confined Stark Effect (QCSE), when a reverse bias is applied to the multiple quantum (MQW) structure, absorption due to generation of an exciton of the multiple quantum well structure may be moved to a long wavelength due to reduction of the band gap.

As illustrated in FIG. 6, when a reverse bias is applied to the coupled asymmetric multiple quantum well structure, band gap energy (e.g., lowest band gap energy), i.e., a difference between the fifth eigenvalue EV5 of the conduction band and the seventh eigenvalue EV7 of the valence band in the second quantum well may be reduced. Accordingly, an interband transition wavelength may move to a long wavelength.

Also, the probability distribution of the fifth eigenfunction EF5 may become lower. That is, a probability that interband transition between the seventh eigenfunction EF7 of the valence band and the fifth eigenfunction EF5 of the conduction band of the second quantum well having a wide thickness occurs may be reduced. Accordingly, a probability that light is absorbed may be reduced.

Accordingly, since the absorption coefficient becomes lowered even when an absorption coefficient curve according to the wavelength moves to a long wavelength, an influence by absorption may be reduced in an operating wavelength range higher than the band gap energy. In one embodiment, the influence by absorption may be ignored in the operating wavelength range higher than the band gap energy.

Also, when a reverse bias is applied, the probability distribution of the sixth eigenfunction EF6 may increase at the second quantum well. That is, since a probability that interband transition between the seventh eigenfunction EF7 of the valence band and the sixth eigenfunction EF6 of the conduction band of the second quantum well having a wide thickness occurs may increase, a probability that light is absorbed may increase. Accordingly, a change of the pattern of the absorption spectrum according to the wavelength may be reduced, or the pattern may be maintained.

A phenomenon opposite to a phenomenon that occurs in the second quantum well may occur in the first quantum well. That is, a probability that interband transition between the sixth eigenfunction EF6 of the conduction band and the eighth eigenfunction EF8 of the valence band occurs may be reduced, but a probability that interband transition between the fifth eigenfunction EF5 and the eighth eigenfunction EF8 occurs may increase. However, the band gap energy of the first quantum well may be greater than the band gap energy of the second quantum well. Accordingly, the effect caused by the phenomenon that occurs in the first quantum well may have no substantial influence on the operation wavelength.

Accordingly, in the coupled asymmetric multiple quantum well structure according to an embodiment of the present invention, when application of a reverse bias allows absorption to move to a long wavelength, an influence of absorption increase in the operating wavelength range may not be significant.

In the coupled asymmetric multiple quantum well (CAMQW) structure, when electrons are evenly distributed to two quantum wells, the absorption may be minimized. In the coupled asymmetric multiple quantum well structure, since the thickness of the first quantum well is less than that of the second quantum well, the second energy level L2 may be higher than the first energy level L1. When application of a reverse bias allows the first energy level L1 to be similar to the second energy level L2, or allows the fifth energy level L5 to be similar to the sixth energy level L6, the eigenfunctions EF5 and EF6 of electrons may be evenly distributed in the first quantum well and the second quantum well.

That is, in the distribution function of the conduction band, as shown in FIG. 6, of the coupled asymmetric quantum well (CAMQW) structure to which a specific voltage is applied, there is no significant influence when an absorption coefficient curve according to the wavelength moves to a long wavelength, and the absorption may be considerably reduced.

According to the Kramers-Kroing relation, when the absorption coefficient curve according to the wavelength moves to a long wavelength, a refractive index at the side of the long wavelength may increase. When the absorption is reduced, the refractive index at the side of the long wavelength may be reduced. As described above, in the coupled asymmetric multiple quantum well (CAMQW) structure according to an embodiment of the present invention, when a reverse bias is applied, an influence according to the long wavelength movement may not be significant, and the absorption may be considerably reduced. Accordingly, the refractive index at the side of the long wavelength may be considerably reduced.

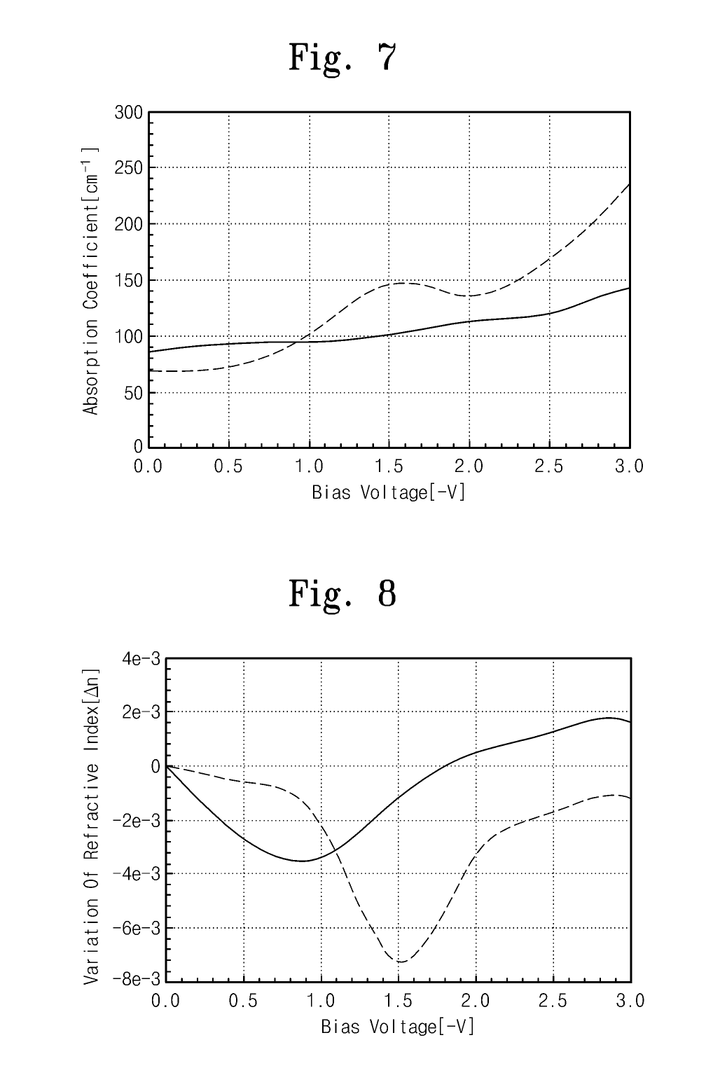

FIG. 7 is a graph illustrating a variation of an absorption coefficient according to a bias voltage. In FIG. 7, the horizontal axis indicates a bias voltage, the unit of which is [−V], and the vertical axis indicates an absorption coefficient, the unit of which is [cm−1].

FIG. 8 is a graph illustrating a variation of a refractive index according to a bias voltage. In FIG. 8, the horizontal axis indicates a bias voltage, the unit of which is [−V], and the vertical axis indicates a variation of the refractive index.

In FIGS. 7 and 8, the solid line shows a change of the absorption coefficient and a variation of the refractive index when the thickness of the first quantum well is about 6 nanometers, the thickness of the second quantum well is about 7.5 nanometers, and the thickness, and the thickness of the second potential barrier is about 4 nanometers. The dotted line shows a change of the absorption coefficient and a variation of the refractive index when the thickness of the first quantum well is about 6 nanometers, the thickness of the second quantum well is about 10 nanometers, and the thickness, and the thickness of the second potential barrier is about 5 nanometers.

Referring to FIGS. 7 and 8, when a reverse voltage is near 1 V, that is, a forward voltage is near −1 V, the variation of the refractive index is maximum. As the reverse voltage increases, the change of the absorption coefficient increases. As the thickness of the second potential barrier between the first quantum well and the second quantum well increases, the variation of the refractive index and the change of the refractive index according to the voltage change increase. In FIGS. 7 and 8, the maximum variation of the refractive index may be about 5.5E-3

FIG. 9 is a graph illustrating an absorption coefficient according to a variation of a bias voltage of a typical multiple quantum well structure. In FIG. 9, the horizontal axis indicates a bias voltage, the unit of which is [−V]. The vertical axis indicates an absorption coefficient.

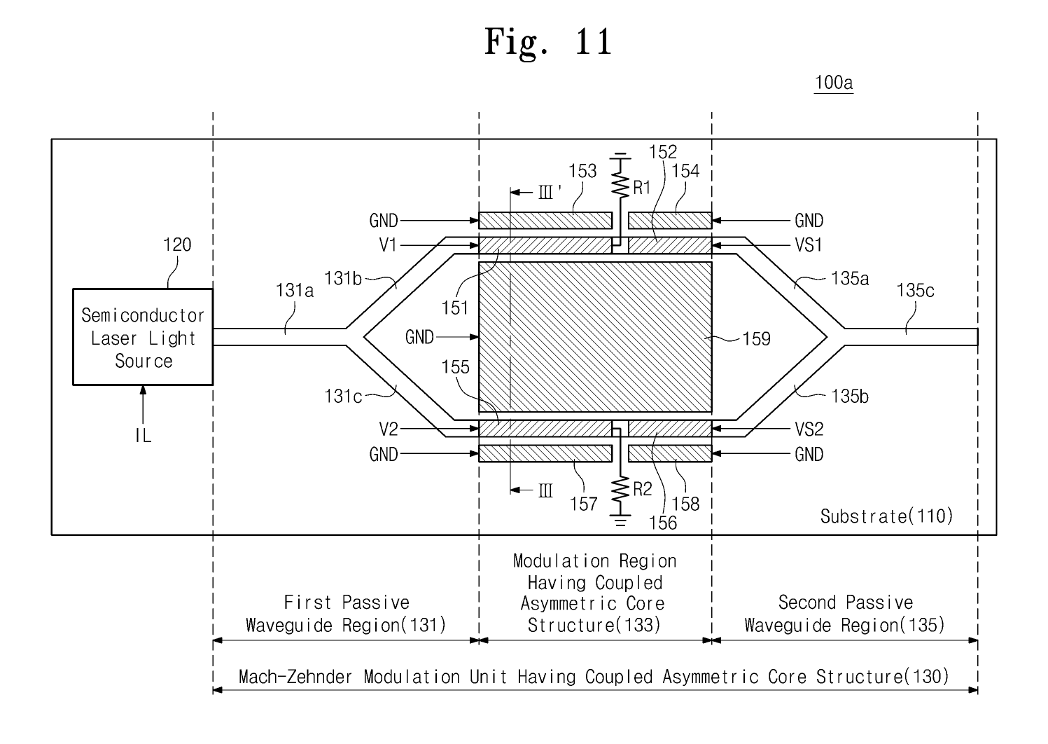

FIG. 10 is a graph illustrating a variation of a refractive index according to a variation of a bias voltage of a typical multiple quantum well structure. In FIG. 10, the horizontal axis indicates a bias voltage, the unit of which is [−V]. The vertical axis indicates a variation of the refractive index.

For example, the variations of the absorption coefficient and the refractive index of a multiple quantum well (MQW) in which there are nine quantum wells having a thickness of about 7.5 nanometers and the thickness of a potential barrier is about 10 nanometers are shown in FIGS. 9 and 10.

The bias voltage may be applied when the absorption coefficient is less than about 150 cm−1. That is, as shown in FIG. 9, the bias voltage may be applied up to about −2 V in the typical multiple quantum well (MQW) structure. In this case, as shown in FIG. 10, the maximum variation of the refractive index may be about 7.5E-4 in the typical multiple quantum well (MQW) structure.

On the other hand, in the coupled asymmetric multiple quantum well (CAMQW) structure according to an embodiment of the present invention as shown in FIG. 7, when the thicknesses of the first quantum well, the second quantum well, and the second potential barrier are about 6 nanometers, about 7.5 nanometers, and about 4 nanometers, respectively, the bias voltage may be applied up to about −3 V. When the thicknesses of the first quantum well, the second quantum well, and the second potential barrier are about 6 nanometers, about 10 nanometers, and about 5 nanometers, the bias voltage may be applied up to about −2.3 V.

In the coupled asymmetric quantum well structure according to an embodiment of the present invention as shown in FIG. 8, when the thicknesses of the first quantum well, the second quantum well, and the second potential barrier are about 6 nanometers, about 7.5 nanometers, and about 4 nanometers, respectively, the maximum variation of the refractive index may be about 3.6E-3. When the thicknesses of the first quantum well, the second quantum well, and the second potential barrier are about 6 nanometers, about 10 nanometers, and about 5 nanometers, the maximum variation of the refractive index may be about 7E-3.

That is, compared to the typical multiple quantum well (MQW) structure, a lower variation of the absorption coefficient and a greater variation of the refractive index may be obtained in the coupled asymmetric multiple quantum well (CAMQW) structure according to an embodiment of the present invention. Accordingly, a modulation voltage or Vit may be significantly reduced.

In the embodiments described above, the coupled asymmetric multiple quantum well (CAMQW) structure has been described with specific numeral values. However, the coupled asymmetric multiple quantum well (CAMQW) structure according to an embodiment of the present invention is not limited to the specific numeral values. Also, when the numeral values of the coupled asymmetric multiple quantum well (CAMQW) structure according to an embodiment of the present invention are modified, specific numeral values of the bias voltage, absorption coefficient, and refractive index variation may be changed.

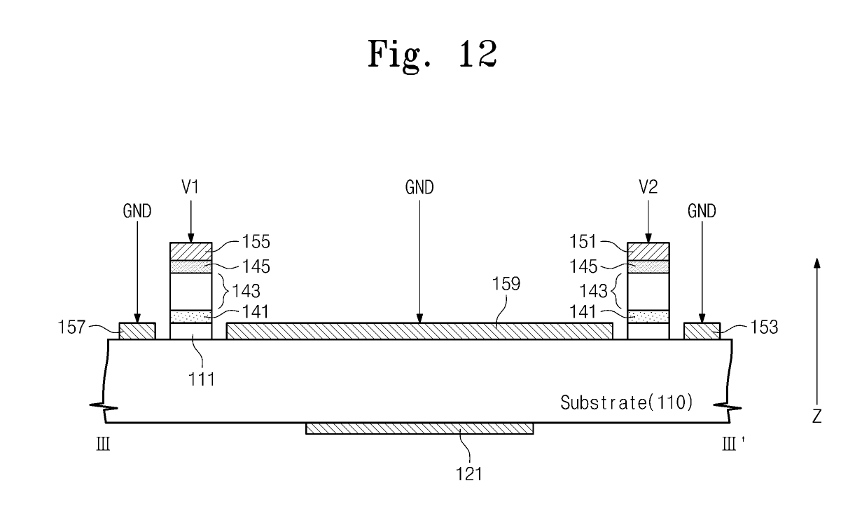

FIG. 11 is a diagram illustrating an optical comb generator 100a with electrodes added according to a first embodiment. FIG. 12 is a cross-sectional view taken along line III-III′ of FIG. 11. For simplicity of explanation, a portion of the reference numerals described in FIGS. 1 through 3 will be omitted in FIGS. 11 and 12.

Compared to the optical comb generator 100 described with reference to FIGS. 1 through 3, the optical comb generator 100a may further include a first electrode 151 and a second electrode 152 that are provided on a first modulator 133a of a coupled asymmetric modulation region 133, a third electrode 153 and a fourth electrode 154 that are provided adjacent to the first modulator 133a on a substrate 110, a fifth electrode 155 and a sixth electrode 156 that are provided on a second modulator 133b, a seventh electrode 157 and an eighth electrode 158 that are provided adjacent to the second modulator 133b on the substrate 110, and a ninth electrode 159 that is provided between the first modulator 133a and the second modulator 133b.

A material 111 may be additionally provided between the substrate 110 and a first layer 141. For example, the material 111 may be provided such that the bottom surface of the first layer 141 have a height equal to or greater than the top surfaces of the third electrode 153, the seventh electrode 157, and the ninth electrode 159. The material 111 may have conductivity. The material 111 may be a semiconductor material having a specific conductive type. The material 111 may include the same material as the substrate 110.

A ground electrode 121 may be provided under the substrate 110. The ground electrode 121 may provide a ground connection to a semiconductor laser light source 120.

Hereinafter, a modulation operation of the optical comb generator 110a will be described in detail with reference to FIGS. 11 and 12.

A current IL may be supplied to the semiconductor laser light source 120. Based on the current IL, the semiconductor laser light source 120 may output single-mode light. Light outputted by the semiconductor laser light source 120 may be divided in a first passive waveguide region 131, and then may be supplied to the first modulator 133a and the second modulator 133b.

A coupled asymmetric multiple quantum well (CAMQW) structure of the first modulator 133a and the second modulator 133b may be reverse-biased. For example, in the coupled asymmetric multiple quantum well (CAMQW) structure of the first modulator 133a and the second modulator 133b, a negative voltage may be applied, or a positive voltage may be applied. For example, when the first layer 141 has a P-conductive type, a positive voltage may be applied through the fourth and eighth electrodes 154 and 158. When the first layer 141 has an N-conductor type, a negative voltage may be applied through the fourth and eighth electrodes 154 and 158.

The first electrode 151 may be connected to the ground voltage through a first resistor R1. The first resistor R1 may have a resistance value of about 50Ω. A modulation voltage may be applied to the first electrode 151. For example, a first sinusoidal wave V1 may be applied to the first electrode 151. A first constant voltage VS1 may be applied to the second electrode 152. The third electrode 153 may be grounded, and the fourth electrode 154 may be grounded.

The fifth electrode 155 may be connected to the ground voltage through a second resistor R2. The second resistor R2 may have a resistance value of about 50Ω. A modulation voltage may be applied to the fifth electrode 155. For example, a second sinusoidal wave V2 may be applied to the fifth electrode 155. A second constant voltage VS2 may be applied to the sixth electrode 156. The seventh electrode 157 may be grounded, and the eighth electrode 158 may be grounded.

The ninth electrode 159 provided on the substrate 110 between the first modulator 133a and the second modulator 133b may be grounded.

In a region of the first modulator 133a corresponding to the first electrode 151, an electric field may be formed by the first sinusoidal wave V1 applied to the first electrode 151, and the ground applied to the third electrode 153 and the ninth electrode 159. As the first sinusoidal wave V1 is modulated, the refractive index of the coupled asymmetric multiple quantum well (CAMQW) structure may vary. That is, due to the voltages of the first electrode 151, the third electrode 153, and the ninth electrode 159, the single-mode light inputted into the first modulator 133a may be phase-modulated by the change of the refractive index, and may be converted into a harmonic wave.

In a region of the second modulator 133b corresponding to the fifth electrode 155, an electric field may be formed by the second sinusoidal wave V2 applied to the fifth electrode 155, and the ground applied to the seventh electrode 157 and the ninth electrode 159. As the second sinusoidal wave V2 is modulated, the refractive index of the coupled asymmetric multiple quantum well (CAMQW) structure may vary. That is, due to the voltages of the fifth electrode 155, the seventh electrode 157, and the ninth electrode 159, the single-mode light inputted into the second modulator 133b may be phase-modulated by the change of the refractive index, and may be converted into a harmonic wave.

In a region of the first modulator 133a corresponding to the second electrode 152, an electric field may be formed by the first constant voltage VS1 applied to the second electrode 152, and the ground voltage applied to the fourth electrode 154 and the ninth electrode 159.

In a region of the second modulator 133b corresponding to the sixth electrode 156, an electric field may be formed by the second constant voltage VS2 applied to the sixth electrode 156, and the ground voltage applied to the eighth electrode 158 and the ninth electrode 159.

The first constant light VS1 and the second constant light VS2 may be adjusted such that the light modulated by the first modulator 133a and the light modulated by the second modulator 133b are modulated into different phases. For example, The first constant light VS1 and the second constant light VS2 may be adjusted such that the light modulated by the first modulator 133a and the light modulated by the second modulator 133b are modulated to have different phases. One of the light modulated by the first modulator 133a and the light modulated by the second modulator 133b may constitute an in-phase component, and the other may constitute a quadrature-phase component.

The light modulated by the first modulator 133a and the light modulated by the second modulator 133b may be combined in the second passive waveguide region 135 to form an optical comb.

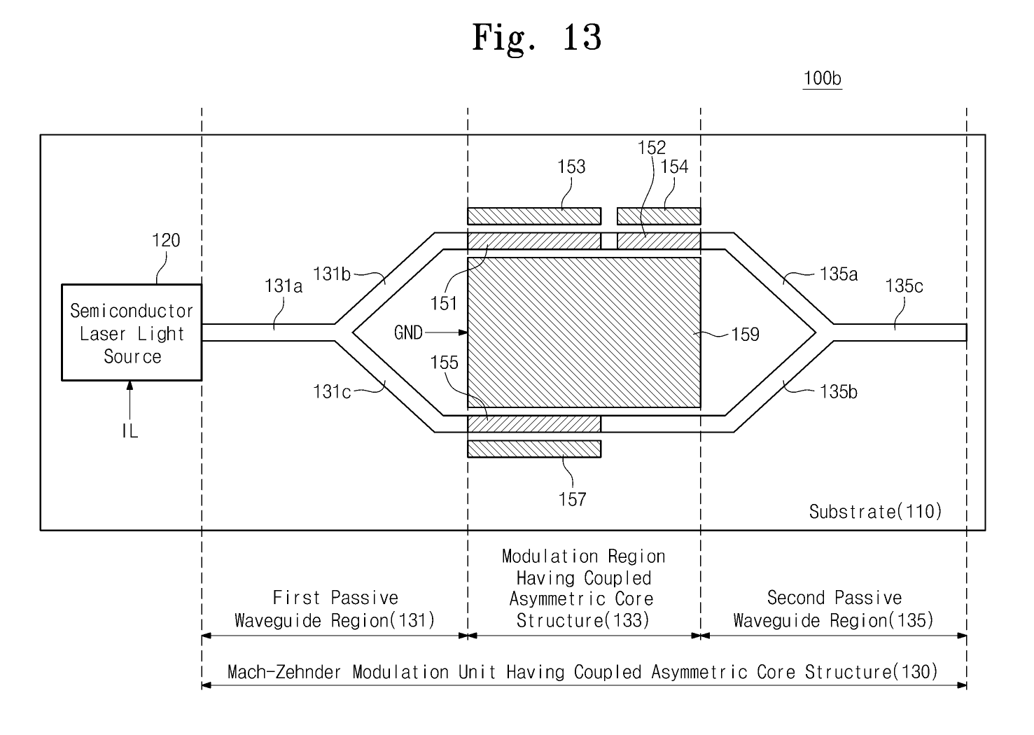

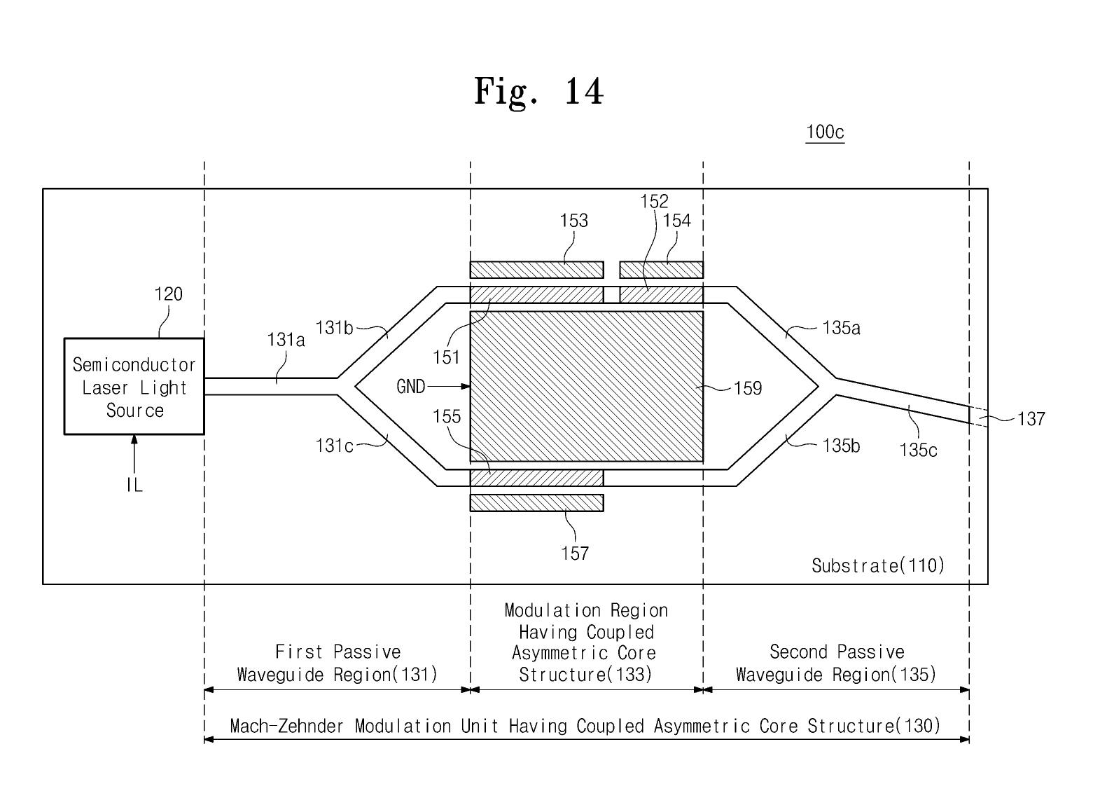

FIG. 13 is a diagram illustrating an optical comb generator 100b with electrodes added according to a second embodiment. Compared to the optical comb generator 100a described with reference to FIGS. 11 and 12, a sixth electrode 156 to which a second constant voltage VS2 is applied may be removed from a second modulator 133b of the optical comb generator 100b. Also, an eighth electrode 158 which is disposed adjacent to the second modulator 133b on a substrate 110 and the ground voltage is applied to may be removed.

Controlling of a phase difference between light modulated by a first modulator 133a and light modulated by the second modulator 133b may be achieved by applying a constant voltage to one of the first modulator 133a and the second modulator 133b. It has been described in FIG. 13 that a second electrode 152 to which the first constant voltage VS1 is applied is provided to the first modulator 133a. However, the second electrode 152 to which the first constant voltage VS1 is applied may be removed from the first modulator 133a, and the sixth electrode 156 to which the second constant voltage VS2 is applied may be provided to the second modulator 133a.

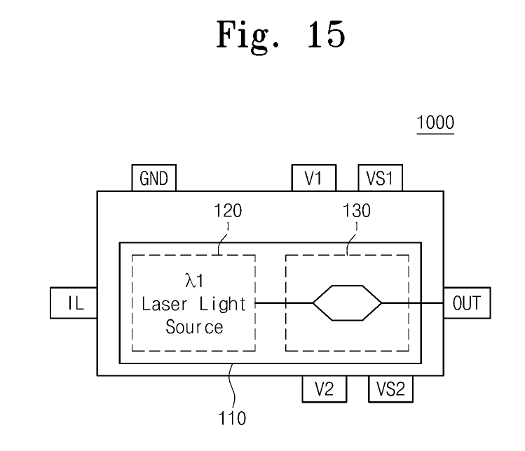

FIG. 14 is a diagram illustrating a diagram illustrating an optical comb generator 100c with electrodes added according to a third embodiment. Compared to the optical comb generator 100b described with reference to FIG. 13, an output arm 135c of a second passive waveguide region 135 of the optical comb generator 100c may have an inclined structure. More specifically, the output arm 135c may incline from an axial line along which an input arm 131a of a first passive waveguide region 131 is provided on a substrate 110. When the output arm 135c has the inclined structure, the reflectance may be reduced at the section of the output terminal.

In order to further reduce the reflectance of the output arm 135c, an anti-reflection coating may be additionally provided to the output terminal of the output arm 135c.

In order to further reduce the reflectance of the output arm 135c, the same semiconductor material as a substrate may be provided to an end 137 of the output arm 135c. Since the refractive index of a semiconductor is greater than that of air, light reflected from the end 137 of the output arm 135c may be refracted and reflected. Accordingly, an influence on light propagating through the output arm may be reduced.

FIG. 15 is a diagram illustrating an optical comb generation package 1000 according to a first embodiment of the present invention. Referring to FIG. 15, the optical comb package 1000 may include a substrate 110, a laser light source 120, and a Mach-Zehnder modulation unit 130.

As described with reference to FIGS. 1 through 14, the laser light source 120 and the Mach-Zehnder modulation unit 130 according to an embodiment of the present invention may be integrated into one substrate. Accordingly, the substrate 110, the laser light source 120, and the Mach-Zehnder modulation unit 130 according to an embodiment of the present invention may be integrated into one package.

The laser light source 120 may generate single-mode light, the central wavelength of which is about λ1. The Mach-Zehnder modulation unit 130 may modulate the output of the laser light source 120 to output an optical comb, the central wavelength is about λ1.

In the optical comb generation package 100, a pad IL to which a current controlling the wavelength of the laser light source 120 is supplied, a ground pad GND, pads V1 and V2 to which harmonic waves used as modulation voltages are supplied, a least one pad (e.g., at least one of the VS1 and VS2) to which a constant voltage is supplied, and a pad OUT through which the output light is outputted.

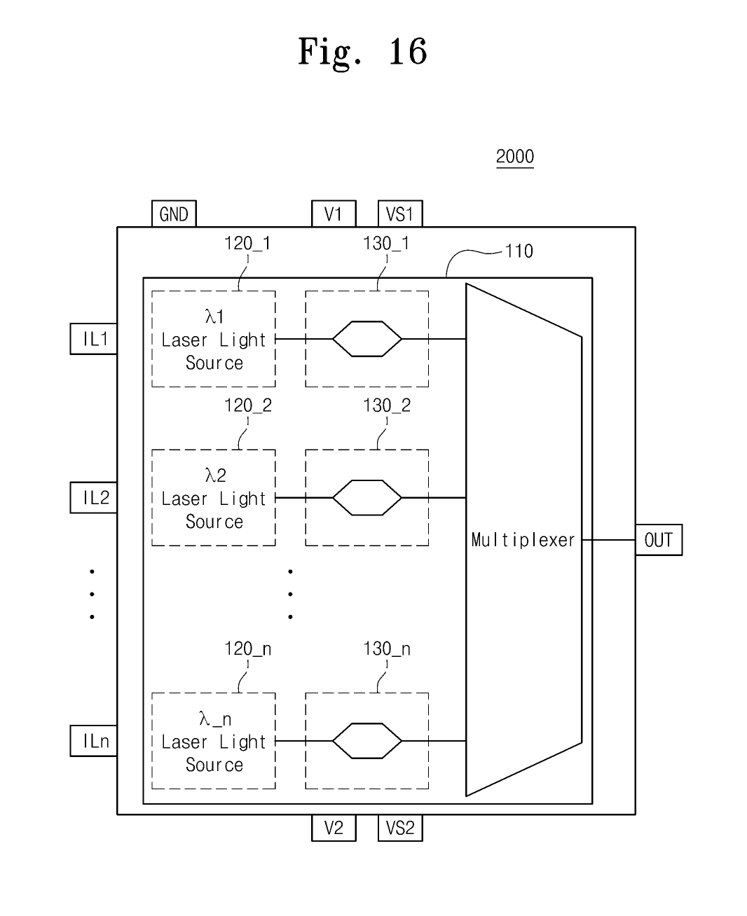

FIG. 16 is a diagram illustrating an optical comb generation package 2000 according to a second embodiment of the present invention. Referring to FIG. 16, the optical comb generation package 2000 may include a substrate 110, first to n-th laser light sources 120_1 to 120_{—}n, first to n-th Mach-Zehnder modulation units 130_1 to 130_{—}n, and a multiplexer.

A laser light source and a Mach-Zehnder modulation unit according to an embodiment of the present invention may be integrated one substrate. Accordingly, a plurality of laser light sources and a plurality of Mach-Zehnder modulation units may be provided to form an array.

The first laser light source 120_1 may generate single-mode light having a central wavelength of about λ1. The first Mach-Zehnder modulation unit 130_1 may modulate the output of the first laser light source 120_1 to output an optical comb having a central wavelength of about λ1.

The laser light source 120_2 may generate single-mode light having a central wavelength of about λ2. The second Mach-Zehnder modulation unit 130_2 may modulate the output of the second laser light source 120_2 to output an optical comb having a central wavelength of about λ2.

The n-th laser light source 120_{—}n may generate single-mode light having a central wavelength of about λ_n. The n-th Mach-Zehnder modulation unit 130_{—}n may modulate the output of the n-th laser light source 120_{—}n to output an optical comb having a central wavelength of about λn.

The multiplexer may multiplex outputs of the first Mach-Zehnder modulation units 130_1 to 130_{—}n. When one of the Mach-Zehnder modulation units 130_1 to 130_{—}n outputs k optical combs, the multiplexer may be configured to output k×n optical combs having the central wavelengths of about λ1 to about λ_n.

The central wavelengths of the first laser light source 120_1 to the n-th laser light source 120_{—}n may be different from each other. Accordingly, a plurality of pads IL1 to ILn to which currents are supplied to control the central wavelengths of the first laser light source 120_1 to the n-th laser light source 120_{—}n may be provided to the optical comb generator 2000.

The ground voltage GND, modulation voltage, and constant voltage may be commonly used in the first to n-th laser light sources 120_1 to 120_{—}n and the first to n-th Mach-Zehnder modulation units 130_1 to 130_{—}n. Accordingly, the ground pad GND, pads V1 and V2 to which harmonic waves are supplied, and at least one pad (at least one of VS1 and VS2) to which the constant voltage is supplied may be shared by the first to n-th laser light sources 120_1 to 120_{—}n and the first to n-th Mach-Zehnder modulation units 130_1 to 130_{—}n. Accordingly, the size of the optical comb generator 2000 can be reduced.

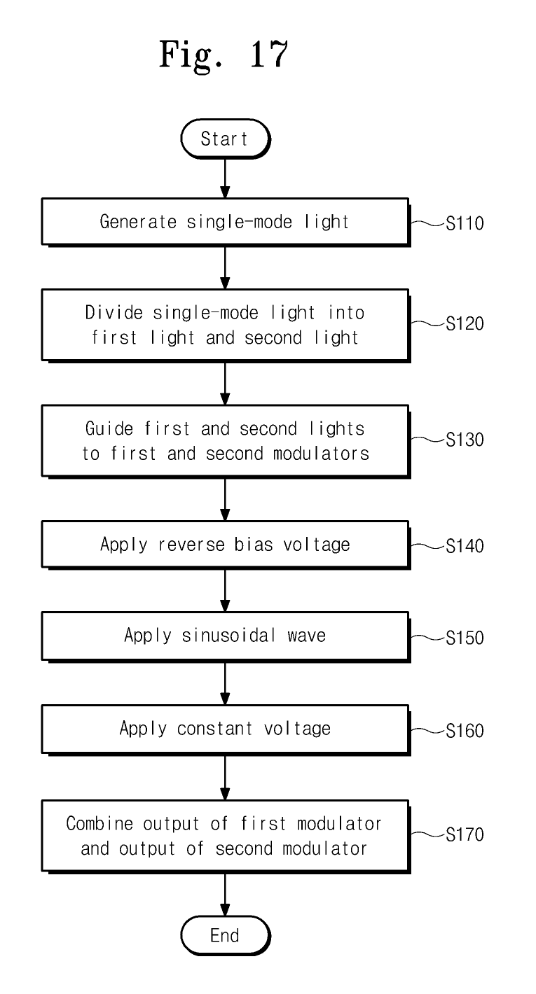

FIG. 17 is a flowchart illustrating an optical comb generation method according to an embodiment of the present invention. The optical comb generation method will be described with reference to FIGS. 11 and 17. However, the optical comb generation method according to an embodiment of the present invention may be performed by any of the optical comb generators 100, 100a, 100b and 100c, and the optical comb generation packages 1000 and 2000.

Referring to FIGS. 11 and 17, in operation S110, single-mode light may be generated. For example, single-mode light may be generated by the semiconductor laser light source 120.

In operation S120, the single-mode light may be divided into first light and second light. For example, the single-mode light inputted to the input arm 131a of the first passive waveguide region 131 may be divided into two lights by the first arm 131b and the second arm 131c.

In operation S130, the first and second light may be guided to the first modulator and the second modulator. For example, the output light of the first arm 131b may be delivered to the first modulator 133a. The output light of the second arm 131c may be delivered to the second modulator 133b. More specifically, the output light of the first arm 131b and the output light of the second arm 131c may be guided to the first modulator 133a and the second modulator 133b having a coupled asymmetric multiple quantum well (CAMQW) structure, respectively.

In operation S140, a reverse bias voltage may be applied. For example, a reverse bias voltage may be applied to the coupled asymmetric multiple quantum well (CAMQW) structure of the first modulator 133a and the second modulator 133b, respectively. For example, the reverse bias voltage may be applied through the first and second electrodes V1 and V2.

In operation S150, a sinusoidal wave may be applied. For example, a first sinusoidal wave V1 may be applied to the first electrode 151 on the first modulator 133a, and a second sinusoidal wave V2 may be applied to the fifth electrode 155 on the second modulator 133b. For example, the first and second sinusoidal waves V1 and V2 may have the same phase. The first and second sinusoidal waves V1 and V2 may serve as a modulation voltage in the first modulator 133a and the second modulator 133b, respectively.

In operation S160, a constant voltage may be applied. For example, a first constant voltage VS1 may be applied to the second electrode 152 on the first modulator 133a, and a second constant voltage VS2 may be applied to the sixth electrode 156 on the second modulator 133b. For example, the first and second constant voltages VS1 and VS2 may be controlled such that the output lights of the first modulator 133a and the second modulator 133b have different phases.

In operation S170, the output of the first modulator and the output of the second modulator may be combined. For example, light inputted into the third arm 135a and light inputted into the fourth arm 135b of the second passive waveguide region 135 may be combined (or interfered) to be outputted through the output arm 135c.

According to an embodiment of the present invention, a modulation of an optical comb generator may be implemented in at least two quantum wells having different thicknesses from each other. Accordingly, there is provided an optical comb generator that is integrated in one substrate and has a stable optical comb generation capability.

Also, since the optical comb generator is integrated in one substrate, a plurality of optical comb generators can be formed in an array form on one substrate. That is, there is provided an optical comb generator that is implemented in an array from on one substrate.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical comb generator comprising:
a light source configured to output single-mode light;
a first waveguide region dividing an output of the light source into first light and second light;
a modulation region comprising a first modulator and a second modulator modulating the first light and the second light respectively; and
a second waveguide region combining outputs of the first modulator and the second modulator to output an optical comb,
wherein the first modulator and the second modulator respectively comprise a first quantum well and a second quantum well having an asymmetric structure with respect to each other, and the light source, the first waveguide region, the modulation region, and the second waveguide region are integrated into one substrate.

2. The optical comb generator of claim 1, wherein the first and second modulators further comprise:
a first semiconductor layer having a first conductive type and stacked on the substrate; and
a second semiconductor layer provided on the first quantum well and the second quantum well and having a second conductive type different from the first conductive type, respectively, and
the first quantum well and the second quantum well are provided on the first semiconductor layer.

3. The optical comb generator of claim 2, wherein the first quantum well and the second quantum well have different thicknesses.

4. The optical comb generator of claim 2, wherein the first quantum well and the second quantum well have different bandgaps.

5. The optical comb generator of claim 3, wherein the first quantum well and the second quantum well have different thicknesses and different bandgaps.

6. The optical comb generator of claim 2, wherein the first semiconductor layer, the first quantum well, the second quantum well, and the second semiconductor layer are reverse-biased.

7. The optical comb generator of claim 1, wherein a potential barrier between the first quantum well and the second quantum well has a thickness in which the first quantum well and the second quantum well are mutually combined.

8. The optical comb generator of claim 7, wherein the thickness of the potential barrier between the first quantum well and the second quantum well is less than about 7 nanometers.

9. The optical comb generator of claim 1, wherein a thickness of the first quantum well is equal to or less than a thickness of the second quantum well, and the thickness of the second quantum well is less than about 12 nanometers.

10. The optical comb generator of claim 1, wherein the modulation region further comprises:
a first potential electrode that is disposed on the first modulator and a sinusoidal wave is applied to;
a second potential electrode that is disposed on the second modulator and a sinusoidal wave is applied to;
at least one third potential electrode that is disposed at an upper portion of at least one of the first modulator and the second modulator to be spaced from the first potential electrode and the second potential electrode and a constant voltage is applied to; and
at least one ground electrode that is disposed on the substrate to be adjacent to the first modulator and the second modulator and is grounded.

11. The optical comb generator of claim 1, wherein the first waveguide region comprises an input arm guiding output light from the light source, and first and second arms dividing and outputting the guided light into first light and second light, respectively, and
the second waveguide region comprises third and fourth arms configured to guide modulated lights in the first and second modulators, respectively, and an output arm combining and outputting the guided lights through the third and fourth arms.

12. The optical comb generator of claim 11, wherein the output arm has an inclined structure with respect to an axial line along which the input arm is provided on the substrate.

13. An optical comb generator comprising:
a plurality of light sources generating single-mode lights having different wavelengths;
a plurality of modulation units corresponding to the plurality of light sources, and configured to modulate output lights from the plurality of light sources to output optical combs having different central wavelengths, respectively; and
a multiplexer configured to multiplex outputs of the plurality of modulation units to output,
wherein a first modulator and a second modulator comprise at least two quantum wells having an asymmetric structure with respect to each other, respectively, and the plurality of light sources, the plurality of modulation units, and the multiplexer are integrated into one substrate.

14. The optical comb generator of claim 13, wherein the at least two quantum wells are mutually combined.

15. The optical comb generator of claim 13, wherein the at least two quantum wells have different thicknesses.
